(19) United States
(12) Patent Application Publication
(10) Pub. No.: US 2026/0322708 A1
(43) Pub. Date: Oct. 15, 2026

(54) 6G MODEL CARD DATA FOR AI/ML MODEL TRANSPARENCY

(71) Applicant: Intel Corporation, Santa Clara, CA (US)

(72) Inventors: Xiaopeng Tong, Beijing 11 (CN); Qian Li, Beaverton, OR (US); Zongrui Ding, Portland, OR (US)

(21) Appl. No.: 19/485,957

(22) PCT Filed: Nov. 15, 2024
(86) PCT No.: PCT/US2024/056220

§ 371 Date: Nov. 19, 2025

(30) Foreign Application Priority Data
Dec. 5, 2023 (WO) PCT/CN2023/136361

(51) Int. Cl. H04L 41/16; H04L 67/303

(52) U.S. Cl. CPC H04L 41/16; H04L 67/303

(57) ABSTRACT

A system and methods for enhancing Artificial Intelligence/Machine Learning (AI/ML) model transparency in 6^{th} generation (6G) networks are introduced through the use of model cards. The model cards provide detailed metadata about AI/ML models, including architecture, training data, and performance metrics, in a machine-readable JSON format. The model card is exposed via network function service or retrieved via a Network Repository Function (NRF), or a dedicated model card registry network function is used to provide the model card. The model card enables visibility for service consumers into AI/ML models used, allowing for the evaluation of trustworthiness and promoting transparency and accountability in AI-driven 6G networks.

### PRIORITY CLAIM

This application claims the benefit of priority to International Application No. PCT/CN2023/136361, filed Dec. 5, 2023, which is incorporated herein by reference in its entirety.

### TECHNICAL FIELD

Embodiments pertain to wireless networks and wireless communications. Some embodiments relate to mechanisms for enhancing Artificial Intelligence/Machine Learning (AI/ML) model transparency in 6th generation (6G) networks through the use of model cards.

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such, the complexity of such communication systems, as well as interactions between elements within a communication system, has increased. For example, the increasing implementation of AI/ML models in all walks of technology poses significant issues when used in communication systems. Notably, there is a lack of transparency in AI/ML models within 5G Service-Based Architecture (SBA), which is used for trustworthy AI-driven 6G networks. Current systems do not provide sufficient visibility into such models, making it difficult for consumers to evaluate their trustworthiness.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates functionalities and service interfaces of an AI/ML-driven network function in accordance with some embodiments.

FIG. 4 illustrates system procedures of the AI/ML-driven network function shown in FIG. 3 in accordance with some embodiments.

FIG. 5 illustrates functionalities and service interfaces of an AI/ML-driven network function and interactions with a network repository function (NRF) in accordance with some embodiments.

FIG. 6 illustrates system procedures of the AI/ML-driven network function shown in FIG. 5 in accordance with some embodiments.

FIG. 7 illustrates functionalities and service interfaces of an AI/ML-driven network function and interactions with a dedicated model card registry network function in accordance with some embodiments.

FIG. 8 illustrates system procedures of the AI/ML-driven network function shown in FIG. 7 in accordance with some embodiments.

FIG. 9 illustrates uniform resource identifiers (URIs) of the model card management service in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

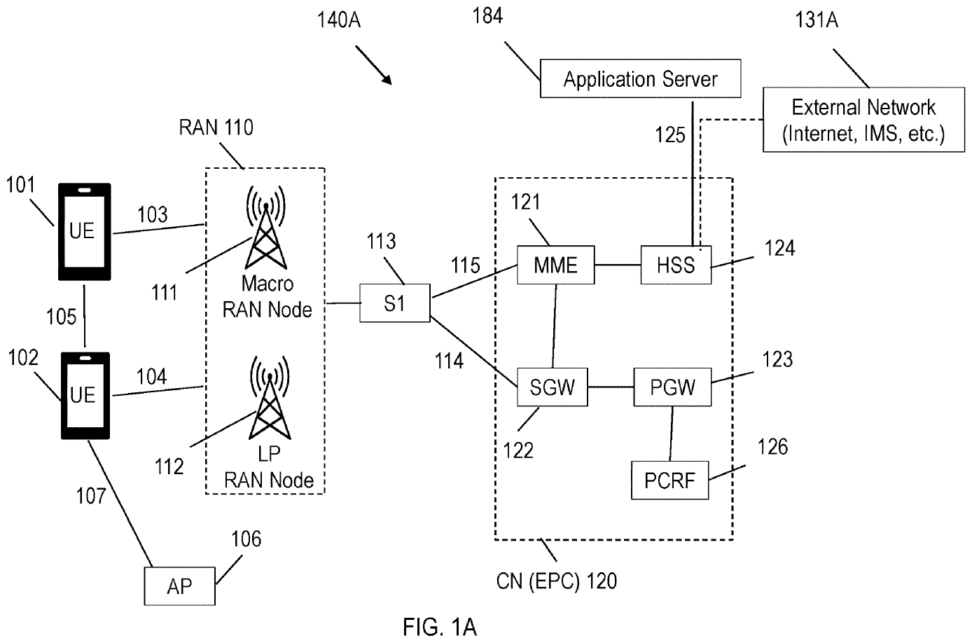

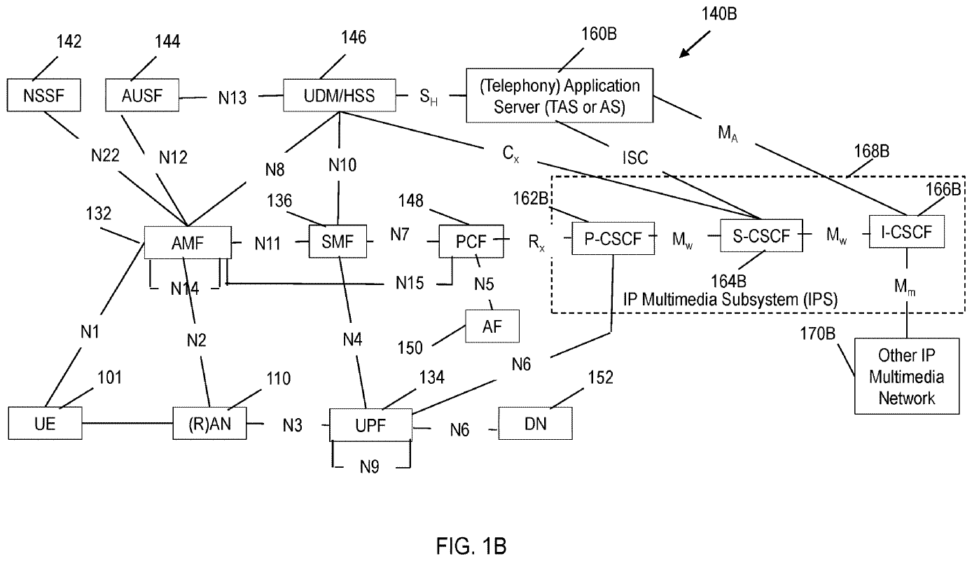

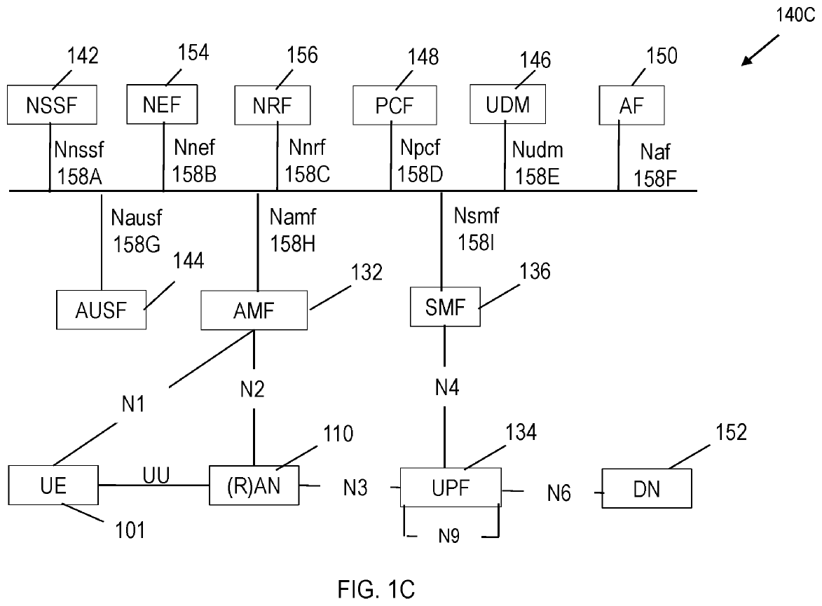

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions.

The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

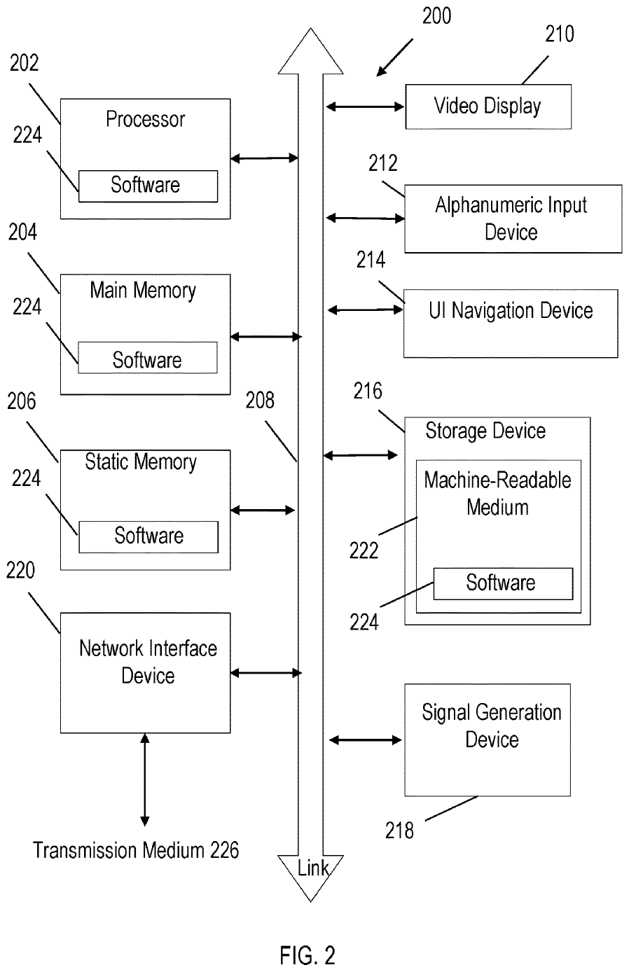

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-IC. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mm Wave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to IT'S for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHZ, 37-38.6 GHZ, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, due to the wide and rapid acceptance of AI/ML in technology, it may be desirable for 6G systems to be AI-native, with AI and ML being integral to enabling advanced use cases and powering intelligent network functions. However, the design of AI in 6G systems is to comply with trustworthy requirements like model transparency, security, and privacy. In this regard, current Service-Based Architecture (SBA) network function service framework (service discovery and registration), the NRF only contains limited model related metadata in the NF profile registered by an AI/ML-driven network function services such as supported analytics and confidence levels (for example, Network Data Analytics Function (NWDAF) NFProfile). The actual ML models driving the services remain opaque black-boxes to consumers. Thus, network function consumers may be unable to evaluate the transparency, accountability, and trustworthiness of AI/ML models by inspecting aspects of the model such as training data, performance metrics, fairness, robustness, and other model characteristics that determine trustworthiness.

To this end, the transparency of AI/ML models used may be enhanced with a model card. The model card may be a type of model metadata that describes information about a model. The model card may promote transparency and accountability around AI systems and may address trustworthiness for the telecommunications use cases. The information provided may include, for example, model details (such as architecture, training data, evaluation results) and performance metrics. This information may be representable in a JSON format which allows the information to be easily parsed and analyzed programmatically, thereby achieving visibility into the lifecycle of a model, from designing, building, training, and evaluation. In addition, to enable model transparency through standards-based model cards, the interaction procedures between AI/ML-driven network function and the service consumer are enhanced to allow service consumers to retrieve model cards and make informed decisions regarding selection and usage of network services in 6G systems.

Several options may be used to incorporate model cards into the 6G system: Option 1: Expose Model Card Data via Network Function Service; Option 2: Retrieve Model Card Data via NRF; and Option 3: Dedicated Model Card Registry Network Function. These may be used separately or in combination.

### Option 1: Expose Model Card Data via Network Function Service

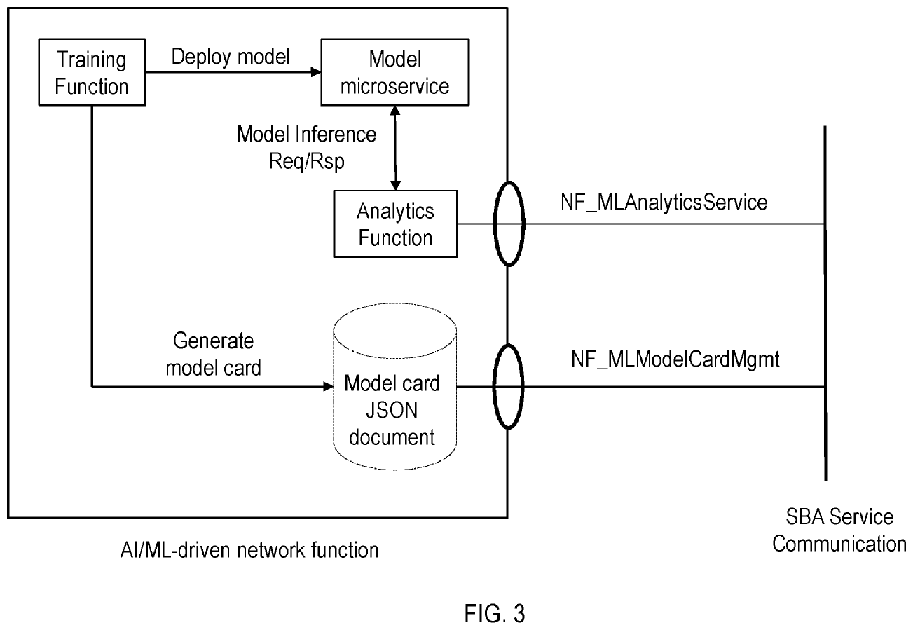

In this option, a model card resource is added with a URI and related service operations that can be accessed as an AI/ML-driven network function service. The details of each model card can then be retrieved by consumers via RESTful application programming interfaces (APIs) exposed by the network function service. FIG. 3 illustrates functionalities and service interfaces of an AI/ML-driven network function in accordance with some embodiments.

As shown in FIG. 3, within the network function a training module trains an ML model and deploys the ML model as a model microservice to handle inference. The training module also generates a model card in JSON format for the model, storing the model card in a self-container model card database in the network function. This may be implemented as an Unstructured Data Storage Function (UDSF) network function.

An analytics service consumer can request a model card from the NF_MLModelCardManagement interface to evaluate if the model meets a desired trustworthiness criteria before consuming the service.

Afterwards, the analytics service consumer requests analytics from the NF_MLAnalytics interface. Internally, the analytics function sends inference requests to the appropriate model microservice to generate predictions and provide a result based on the predictions to the service consumer.

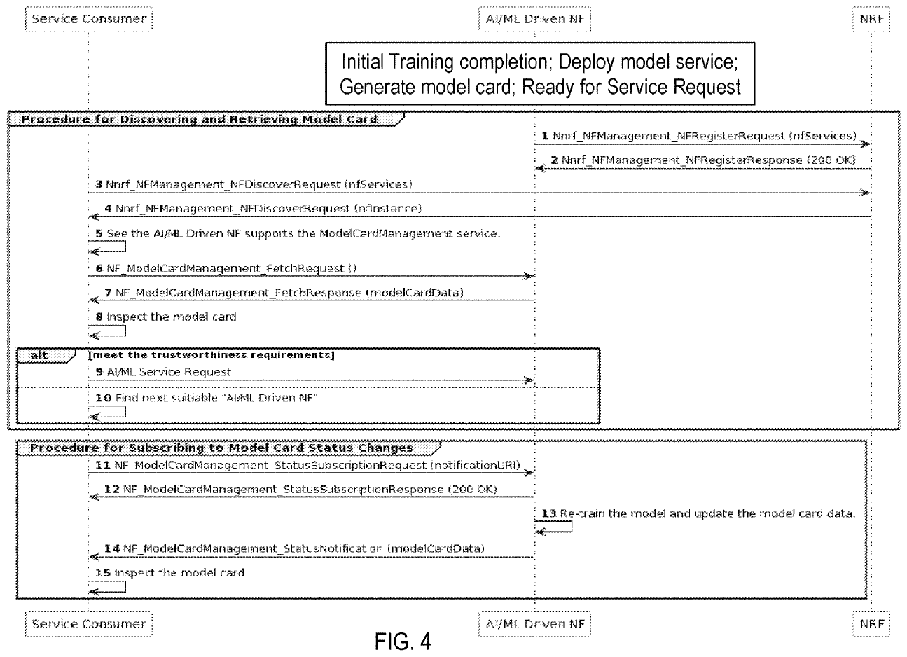

FIG. 4 illustrates system procedures of the AI/ML-driven network function shown in FIG. 3 in accordance with some embodiments. Initially, the AI/ML-driven NF completes the training (i.e., initial training of the AI/ML model), deploys the model service, and generates the model card (which contains the model card data).

At operation 1, the AI/ML-driven NF registers with the NRF. The registration message may include the network function (NF) profile. The NF profile may contain NF type, supported services (which may include the new ModelCardManagement service), and other NF profile information.

At operation 2, the NRF responds confirming the registration. On success, “200 OK” is returned; on failure or redirection, the NRF returns a 4xx or 3xx error response, with additional details as per the NRF API specification. However, it is assumed for this procedure that the NRF processed the NF registration request successfully and stored the NF profile data, responding with a 200 OK status.

At operation 3, the service consumer sends an NF discovery request to the NRF. The service consumer may be another network function, third-party application function, or UE. The NF discovery request contains query parameters to filter the search, such as: NF type—e.g. NWDAF, supported service—e.g. ModelCardManagement service, and other attributes like NF name, ID, or version.

At operation 4, the NRF uses the query parameters to find NF profiles matching the consumer's search criteria out of all registered network functions and responds with the suitable AI/ML-driven NF instances information.

At operation 5, by reviewing the supported services in the profiles, the consumer confirms that the discovered NFs have the ModelCardManagement service advertised. This indicates the NFs are capable of providing model cards.

At operation 6, the service consumer sends a ModelCardManagement_fetch request to the/modelcards endpoint on the AI/ML-driven NF to fetch a model card. The ModelCardManagement_fetch request includes a query parameter specifying the name of the inference service that the consumer plans to use, such as “?serviceName=QoSAnalytics”.

At operation 7, the AI/ML-driven NF handles the request and returns a 200 OK response containing the model card for the model backing the specified service. The model card information is encoded as a JSON string in the response body.

At operation 8, the service consumer parses the JSON model card and inspects fields such as model accuracy, training data, evaluation results, ethicsConsiderations, etc. to determine if the model meets the consumer's expected level of trustworthiness. The exact evaluation criteria and methods may be implementation-specific.

At operation 9, if the model card meets the trustworthiness requirements, the service consumer sends requests to utilize the AI/ML service from the NF.

At operation 10, the model card does not meet the trustworthiness requirements, the service consumer has the option to discover another suitable AI/ML-driven NF by using the Nnrf_NFDiscovery procedure or selecting from the NF instances obtained from the previous Nnrf_NFDiscovery procedure. Following this, the procedures for model card retrieval and trustworthiness audit may be repeated.

When the model is updated, the update may lead to alterations in the model card. This event may be made known to the service consumer for the purpose of conducting a trustworthiness audit.

At operation 11, the consumer NF subscribes with the AI/ML-driven NF for model card status notifications, providing a notification call back URI of the consumer NF.

At operation 12, the AI/ML-driven NF responds confirming the subscription.

At operation 13, the AI/ML-driven NF may re-train the model and update its model card.

At operation 14, the AI/ML-driven NF sends a model card status notification containing the updated model card JSON payload to the notification callback URI provided by the subscribed consumer NF.

At operation 15, the consumer NF inspects the updated model card and re-evaluates the updated model card.

### Option 2: Retrieve Model Card Via NRF

In this option, the full JSON data for each model card is stored as a string attribute in the NFProfile registered with the NRF during network function registration. Storing the model cards this way enables service consumers to find and get the relevant model cards for network services by calling the NRF's RESTful APIs.

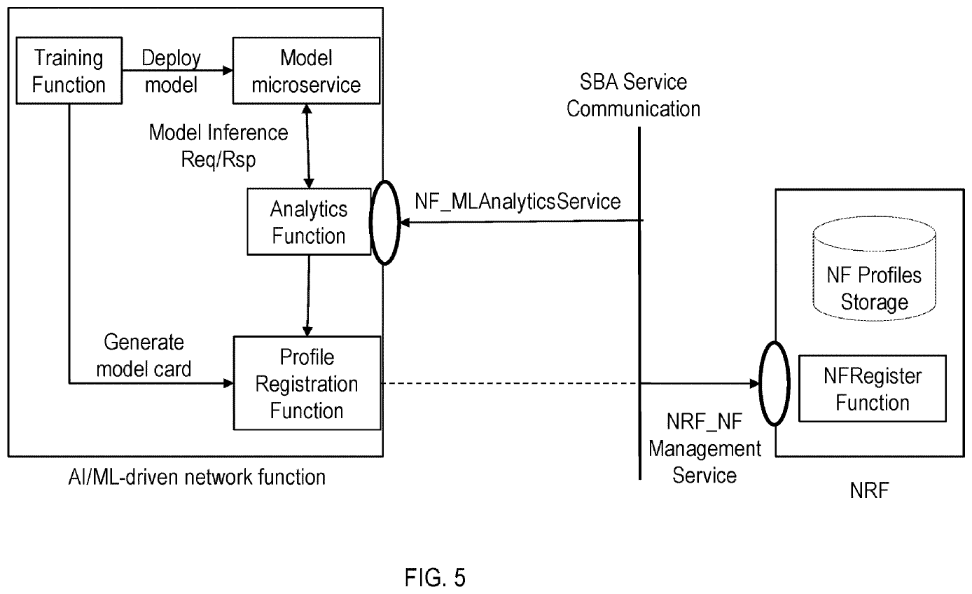

FIG. 5 illustrates functionalities and service interfaces of an AI/ML-driven network function and interactions with a network repository function (NRF) in accordance with some embodiments. As shown in FIG. 5, similar to FIG. 3, inside the network function, a training module trains an ML model and deploys the ML model as a model microservice to handle inferences. The training module also generates a JSON model card for the ML model. The training module then sends the model card to the Profile Registration Function, which inserts the model card as a string attribute in the NFProfile along with other metadata. The Profile Registration Function registers the AI/ML network function and its NFProfile in the NRF using the NRF_NFManagement service.

An analytics service consumer may request the NFProfile of the AI/ML network function from the NRF and retrieve the model card from the NRF. The consumer can then evaluate if the model meets desired trustworthiness criteria before consuming the service.

Afterwards, the analytics service consumer requests analytics from the NF_MLAnalytics interface. Internally, the analytics function sends inference requests to the appropriate model microservice to generate predictions.

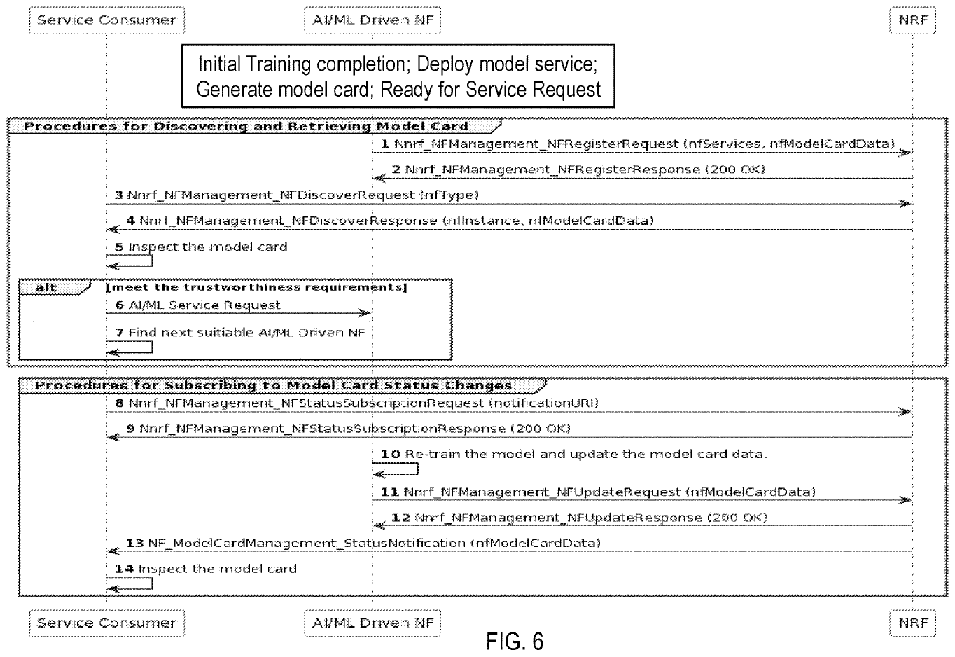

FIG. 6 illustrates system procedures of the AI/ML-driven network function shown in FIG. 5 in accordance with some embodiments. Similar to FIG. 4, Initially, the AI/ML-driven NF completes the training and deploys the model service and generate the model card.

At operation 1, the AI/ML-driven NF registers with the NRF. The registration message may include the NF profile. The NF profile may contain NF type, supported services (which may include the new ModelCardManagement service), and other NF profile information.

At operation 2, the NRF responds confirming the registration. On success, “200 OK” is returned; on failure or redirection, the NRF returns a 4xx or 3xx error response, with additional details as per the NRF API specification. However, it is assumed for this procedure that the NRF processed the NF registration request successfully and stored the NF profile data, responding with a 200 OK status.

At operation 3, the service consumer sends an NF discovery request to the NRF. The service consumer may be another network function, third-party application function, or UE. The NF discovery request contains query parameters to filter the search, such as: NF type—e.g. NWDAF, and other attributes like NF name, ID, or version.

At operation 4, the NRF uses the query parameters to find NF profiles matching the consumer's search criteria out of all registered network functions and responds with the suitable AI/ML-driven NF instances information. This information includes the NF profile information, with the model card being one of the attributes of the NRF profile.

At operation 5, the service consumer parses the JSON model card and inspects fields like model accuracy, training data, evaluation results, ethicsConsiderations, etc. to determine if the model meets the consumer's expected level of trustworthiness. The exact evaluation criteria and methods may be implementation-specific.

At operation 6, if the model card meets the trustworthiness requirements, the service consumer sends requests to utilize the AI/ML service from the NF.

At operation 7, if the model card does not meet the trustworthiness requirements, the service consumer has the option to discover another suitable AI/ML Driven NF by using the Nnrf_NFDiscovery procedure or selecting from the NF instances obtained from the previous Nnrf_NFDiscovery procedure. Following this, the procedures for model card retrieval and trustworthiness audit may be repeated.

When the model is updated, the update may lead to alterations in the model card and updating NF profiles to NRF. This event may be made known to the service consumer for the purpose of conducting a trustworthiness audit.

At operation 8, the consumer NF subscribes with the AI/ML-driven NF for model card status notifications, providing a notification call back URI of the consumer NF.

At operation 9, the NF responds confirming the subscription.

At operation 10, the AI/ML-driven NF may re-train the model and update its model card.

At operation 11, the AI/ML-driven NF sends Nnrf_NFManagement_NFUpdateRequest to the NRF, providing the updated NF profile including model card and other NF profile information.

At operation 12, the NRF responds, confirming the registration.

At operation 13, the NRF sends NF_ModelCardManagement_StatusNotification with the updated NF profile which containing the updated model card JSON payload to the notification callback URI provided by the subscribed consumer NF.

At operation 14, the consumer NF inspects the updated model card and re-evaluates the updated model card.

### Option 3: Dedicated Model Card Registry Network Function

In this option, a new network function dedicated to model registry capabilities is added, serving as a centralized repository for storing, managing, and accessing model cards. The model registry network function allows model cards to be uploaded and retrieved via Restful APIs.

The existing 3GPP data storage network functions—Unstructured Data Storage Function (UDSF), Unified Data Repository Function (UDR) and Analytics Data Repository Function (ADRF)—are not designed for managing a catalog of machine learning model cards. Each has limitations: The UDSF stores dynamic state data without standardized schemas and thus is designed for statelessness. The UDR stores structured data, which means the schema and the access interface is standardized by the 3GPP, and is designed to monitor changing information such as UE location, UE registration state, etc for statistical purposes and analytics. The ADRF stores and retrieves historical data and/or analytics, i.e. data and/or analytics related to past time period that has been obtained by the consumer.

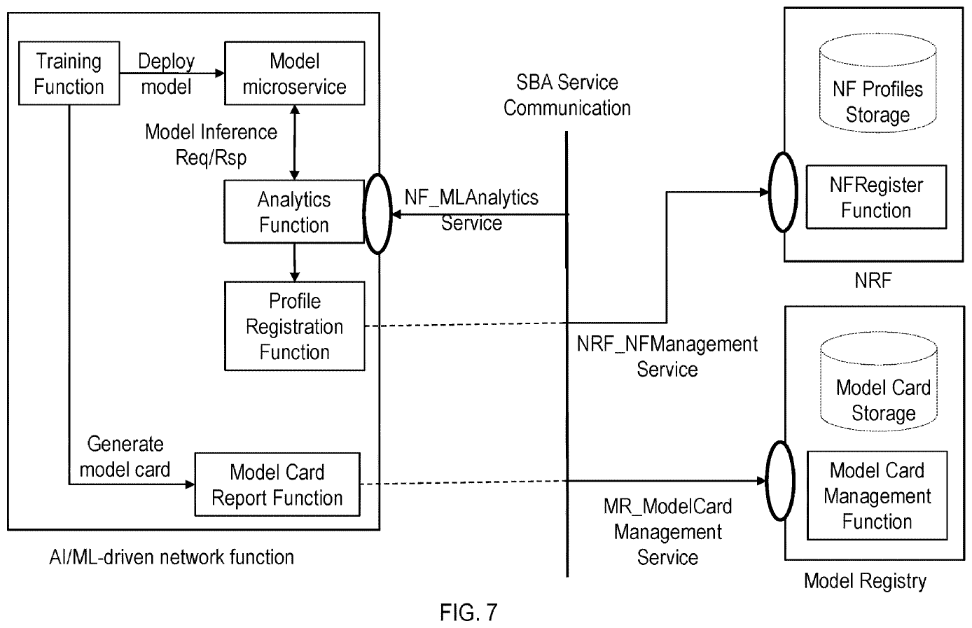

FIG. 7 illustrates functionalities and service interfaces of an AI/ML-driven network function and interactions with a dedicated model card registry network function in accordance with some embodiments. As shown in FIG. 7, a model card management function inside the model registry network function handles requests from other entities for model card reporting and retrieval by exposing a MR_ModelCardManagement service interface and a storage for the model cards.
a training module inside the AI/ML-driven network function trains an ML model and deploys the ML model as a model microservice to handle inferences. The training module also generates a JSON model card for the ML model. The training module then sends the model card to the Model Card Report Function, which reports the model card to the model registry network function for storage. The Profile Registration Function registers the legacy NFProfile in the NRF using the NRF_NFManagement service.

An analytics service consumer can request the model card of the AI/ML network function from the model registry. The consumer can evaluate if the model meets desired trustworthiness criteria before consuming the service. Afterwards, the analytics service consumer requests analytics from the NF_MLAnalytics interface. Internally, the analytics function sends inference requests to the appropriate model microservice to generate predictions.

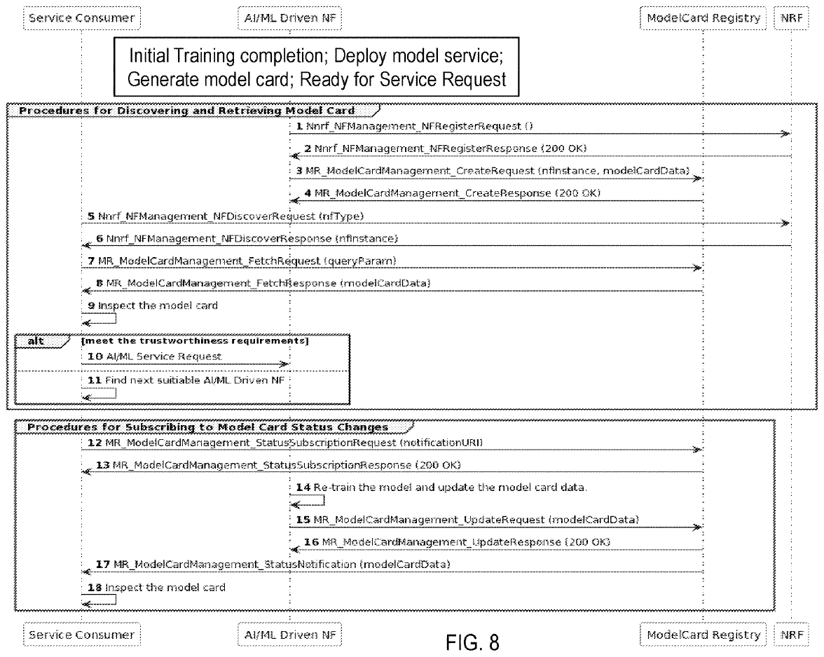

FIG. 8 illustrates system procedures of the AI/ML-driven network function shown in FIG. 7 in accordance with some embodiments. Initially, the AI/ML-driven NF completes the training and deploys the model service and generate the model card.

At operation 1, the AI/ML-driven NF registers with the NRF. The registration message may include the NF profile. The NF profile may contain NF type, supported analytics services, and other NF profile information.

At operation 2, the NRF responds, confirming the registration.

At operation 3, the AI/ML Driven NF sends MR_ModelCardManagement_CreateRequest to the Model Registry, providing the model card, and the corresponding nfInstanceId.

At operation 4, the Model Registry responds, confirming the registration.

At operation 5, the service consumer, which could be another network function, third-party application function, or UE, sends an NF discovery request to the NRF. The NF discovery request contains query parameters to filter the search.

At operation 6, the NRF uses the query parameters to find NF profiles matching the consumer's search criteria out of all registered network functions and responds with the suitable AI/ML-driven NF instances information.

At operation 7, the service consumer sends a MR_ModelCardManagement_Fetch request to the Model Registry. The MR_ModelCardManagement_Fetch request contains the nfInstanceId as a query parameter.

At operation 8, the Model Registry uses the nfInstanceId to find the model card and responds with the model card.

At operation 9, the service consumer parses the JSON model card and inspects fields (e.g., model accuracy, training data, evaluation results, ethicsConsiderations, etc.) to determine if the model meets the consumer's expected level of trustworthiness. The exact evaluation criteria and methods may be implementation-specific.

At operation 10, if the model card meets the trustworthiness requirements, the service consumer sends requests to utilize the AI/ML service from the NF.

At operation 11, if the model card does not meet the trustworthiness requirements, the service consumer has the option to discover another suitable AI/ML-driven NF by using the Nnrf_NFDiscovery procedure or selecting from the NF instances obtained from the previous Nnrf_NFDiscovery procedure. Following this, the procedures for model card retrieval and trustworthiness audit may be repeated.

Updating the model may lead to alterations in the model card and updating NF profiles to the NRF. This event should be made known to the service consumer for the purpose of conducting a trustworthiness audit.

At operation 12, the consumer NF subscribes with the Model Registry for change status notifications, providing a notification call back URI.

At operation 13, the Model Registry responds, confirming the subscription.

At operation 14, the AI/ML-driven NF may re-train the model and update the associated model card.

At operation 15, the AI/ML-driven NF sends MR_ModelCardManagement_UpdateRequest to the Model Registry, providing the model card.

At operation 16, the Model Registry responds, confirming the update.

At operation 17, the Model Registry sends MR_ModelCardManagement_StatusNotification with the updated model card JSON payload to the notification callback URI provided by the subscribed consumer NF.

At operation 18, the consumer NF inspects the updated model card and re-evaluates the updated model card.

| | Option#1 - | | |
|---|---|---|---|
| | Expose Model | Option#2 - | |
| | Card via | Retrieve | |
| | Network | Model | Option#3 - |
| | Function | Card via | Dedicated Model |
| | Service | NRF | Card Registry |
| Standard | Requires new | Aligns | Requires new |
| Impact | standard service | with NRF | standard Model |
| | API for each | standards. A | Card Registry NF |
| | AI/ML driven | Minimal impact | No impact on |
| | NF. | on the schema: | standard service |
| | No impact on | adding a string | framework |
| | standard service | attribute | (service |
| | framework | in the NRF | discovery, |
| | (service | profile. | registration, |
| | discovery, | No impact on | etc). |
| | registration, | standard | |
| | etc). | service | |
| | | framework | |
| | | (service | |
| | | discovery, | |
| | | registration, | |
| | | etc). | |
| Storage | Distributed - NF | Centralized - | Centralized - |
| | self-contained | reuse NRF | new model card |
| | data. | storage. | storage. |
| Implementation | High - AI/ML | Low - reuse | High - new model |
| Complexity | Driven NF code | NRF APIs. | card registry NF |
| | changes needed | AI/ML Driven | development to |
| | to support new | NF code changes | provide model |
| | model card | needed to | card management |
| | management | generate the | services. |
| | service API, | model card | AI/ML Driven |
| | generate the | generation and | NF code |
| | model card | put the model | changes needed |
| | generation, | card into NF | to generate |
| | provide self- | profile. | the model card |
| | contained | | generation, |
| | storage | | facilitate the |
| | (or leverage | | interaction with |
| | UDSF) for the | | the model card |
| | model card. | | registry for its |
| | | | management. |
| Resilience | Resilience | Depends on | Depends on |
| | depends on | overall | overall |
| | individual NFs. | resilience | resilience of |
| | | of centralized | centralized |
| | | NRF. | model card |
| | | | registry. |
| Scalability | Scales with each | Depends on NRF | Can scale model |
| | NF instance | scalability | card registry |
| | | | independently |
| | | | from NRF |

### Model Card Incorporation Option Comparison

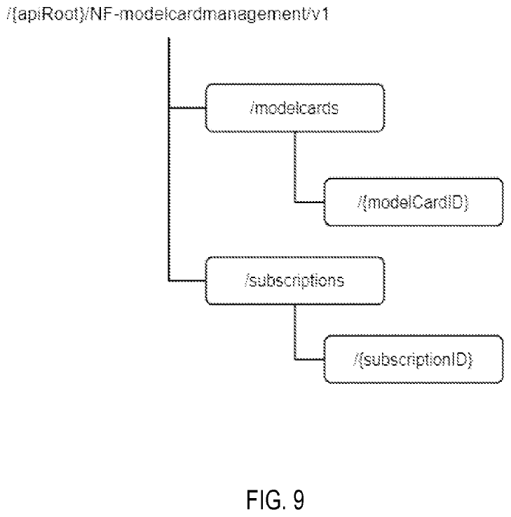

FIG. 9 illustrates URIs of the model card management service in accordance with some embodiments. That is, the structure of the Resource URIs of the model card management service is shown in FIG. 9.

| | | HTTP | |
|---|---|---|---|
| | | method | |
| Resource | | or custom | |
| name | Resource URI | operation | Description |
| modelcards | /modelcards | GET | Read a collection of model cards. |
| | | POST | Create a new model card |
| modelcard | /modelcard/{modelcardID} | GET | Get a given model card. |
| | | PUT | Update a given model card |
| | | Delete | Delete a given model card |
| subscriptions | /subscriptions | POST | Subscribe to Model Card Status |
| | | | Change Events |
| subscription | /subscriptions/{subscriptionID} | PATCH | Updates an existing subscription. |
| | | DELETE | Deletes an existing subscription. |

NOTE:
The “modelcardID” attribute is defined as a string data type and represents a specific model card instance.
The “subscriptionID” attribute is defined as a string data type and represents a specific subscription.

### Resources and Applicable HTTP Methods Overview

The model card payload for create/update requests and responses may follow a JSON schema definition with fields such as: modelCardID, modelCardData, etc.

The subscription payload and notification payload may follow a JSON schema definition with fields such as: modelCardID, notificationURI, changeType (updated/deleted), timestamp, modelCardData etc

| Service operation name | Description | Consumers |
|---|---|---|
| MLmodelcard_Fetch | This service operation is | Network |
| | used by a service consumer | function, |
| | to retrieve the model card | OAM or 3^{rd} |
| | | party |
| | | consumers |
| | | (AF, |
| | | UE, etc.) |
| MLmodelcard_Update | This service operation is | Network |
| | used by a service consumer | function, |
| | to update the model card | OAM or 3^{rd} |
| | | party |
| | | consumers |
| | | (AF, |
| | | UE, etc.) |
| MLmodelcard_Create | This service operation is | Network |
| | used by a service consumer | function, |
| | to create the model card | OAM or 3^{rd} |
| | | party |
| | | consumers |
| | | (AF, |
| | | UE, etc.) |
| MLmodelcard_Delete | This service operation is | Network |
| | used by a service consumer | function, |
| | to delete the model card | OAM or 3^{rd} |
| | | party |
| | | consumers |
| | | (AF, |
| | | UE, etc.) |
| MLmodelcard_Subscribe | This service operation is | Network |
| | used by a service consumer | function, |
| | to subscribe to changes on | OAM or 3^{rd} |
| | the status of the model | party |
| | card. | consumers |
| | | (AF, |
| | | UE, etc.) |
| MLmodelcard_Notify | This service operation is | |
| | used by a service consumer | |
| | to notify subscribed OAM, | |
| | AF, or other network | |
| | function of changes on the | |
| | status of the model card. | |
| MLmodelcard_Unsubscribe | This service operation is | Network |
| | used by a service consumer | function, |
| | to unsubscribe to changes | OAM or 3^{rd} |
| | on the status of the model | party |
| | card. | consumers |
| | | (AF, |
| | | UE, etc.) |

### Services Operations Defined for NF_Modelcardmanagement Service

The model card management APIs can adopt authentication and authorization mechanisms similar to 3GPP's SBA RESTful specifications. This allows access to model cards to be controlled for authorized consumers only.

Model Card Schema Design (full machine readability)

The dominant form of model cards today is human-readable format. There does not appear to be existing 3GPP or other SDO standards that define Full machine readability schema or contents for ML model cards specifically. The schema design can build on existing research and industry formats such as Google's model cards, TensorFlow model card schema, etc adapting them for 6G use cases.

For example, a foundational model card schema may be used that contains core attributes such as model identifier, description, metrics, and intended use by leveraging the existing research and industry formats and 3GPP NWDAF data models. Extensibility mechanisms may allow adding advanced attributes in the future.

| | | | |
|---|---|---|---|
| | Type | | |
| Type Name | Definition | Description | Note |

Model Card Info

| | | |
|---|---|---|
| Id | string($uuid) | String uniquely identifying a model |
| | | card. The format of the model card |
| | | ID shall be a Universally Unique |
| | | Identifier (UUID) version 4, as |
| | | described in IETF RFC 4122. |
| status | Enum(string) | [REGISTERED, SUSPENDED, |
| | | UNDISCOVERABLE] |

Model Details

| name | string | | |
|---|---|---|---|
| version | string | Semantic versioning conventions of | |
| | | MAJOR.MINOR.PATCH | |
| vendorId | string | Vendor ID of the model (Private | |
| | | Enterprise Number assigned by | |
| | | IANA) | |
| license | string | A standard SPDX license identifier | |
| | | (https://spdx.org/licenses/), or | |
| | | “proprietary” for an unlicensed | |
| | | module. | |
| architectureType | Enum(string) | Specifies the overall machine | |
| | | learning model type (e.g. LSTM, | |
| | | Transformer, BERT). | |
| Performance Metrics | | | |
| accuracy | Uinteger | Indicates the accuracy of the ML | Reuse (TS |
| | | model in percent. Minimum = 0. | 29.520 - |
| | | Maximum = 100. | 5.4.6.2.9) |
| precision | Uinteger | Indicates the precision of the ML | Reuse (TS |
| | | model in percent. Minimum = 0. | 29.520 - |
| | | Maximum = 100. | 5.4.6.2.9) |
| recall | Uinteger | Indicates the recall of the ML model | Reuse (TS |
| | | in percent. Minimum = 0. | 29.520 - |
| | | Maximum = 100. | 5.4.6.2.9) |
| f1Score | | F1 score | |
| mse | | Mean squared error | |
| Training DataSet | | | |
| name | string | | |
| description | string | Brief description of the training | |
| | | dataset | |
| link | uri | Link to training dataset info | |
| sensitiveData | Array(string) | A description of any sensitive data in | |
| | | a dataset. | |
| networkDataSource | Array(string) | Where the network data was | |
| | | collected such as | |
| | | AMF, SME, UPF, etc. | |

Intended Use

| | | |
|---|---|---|
| useCaseCategory | Array(string) | List of intended model use cases. |
| | | [“RAN Intelligence”, ” CN |
| | | Intelligence”, “Power Saving”, etc] |
| | | (use case categories) |
| useCase | Array(string) | List of use cases for which this ML |
| | | model can support. |
| | | [“UE_MOBILITY”, ”UE_MOTION_{—} |
| | | TRAJECTORY”, ”RADIO_RESOURCE_{—} |
| | | OPTIMIZATION”, etc] |

Limitations

| | | |
|---|---|---|
| limitationID | Array(string) | List of limitations. |
| | | [“RadioAccessTechnology_Generalization”, |
| | | “Geographic_bias”, etc] |
| limitationAdditionalInformation | Array(String) | Provides supplementary details for |
| | | each identified limitation. |
| | | For example, for the limitateID |
| | | “RadioAccessTechnology_Generalization”, |
| | | it could be |
| | | “OnlylTrainedOnLTE” |

The schema may be encoded as a JSON to align with common SBA data formats, support extensibility and ease adoption. In addition, the new 3GPP model card definition optimized for 6G networks may be introduced in TS 29.571, aligning with the Network Resource Model.

### EXAMPLES

Example 1 is an apparatus of an Artificial Intelligence/Machine Learning (AI/ML)-driven network function in a 6th generation (6G) network, the apparatus comprising a processor configured to: generate a model card containing model card data of an AL/ML model deployed in the AI/ML-driven network function, the model card data including information for evaluation of trustworthiness of the AI/ML model; via a management interface, provide access to the model card in a local memory or register the model card in at least one of a network repository function (NRF) or a dedicated model card registry network; determine that an analytics request for analytics by the AI/ML model has been received, via an analytics interface, from a service consumer after a determination of the trustworthiness of the AI/ML model based on the model card; in response to a determination the analytics request by the AI/ML model has been received, use the AI/ML model to generate predictions; and provide a result based on the predictions to the service consumer.

In Example 2, the subject matter of Example 1 includes, wherein the processor is configured to: provide a network function profile to the NRF to register the AI/ML-driven network function with the NRF, the network function profile including a network function type and supported services; determine that a fetch request from the service consumer has been received, the fetch request including a query parameter specifying a name of an inference service that is to be used; determine that the AI/ML model meets the inference service; and provide a fetch response that includes the model card encoded as a JSON string, the analytics request received after the fetch response is provided.

In Example 3, the subject matter of Example 2 includes, wherein the network function profile further includes the model card for the service consumer to access.

In Example 4, the subject matter of Examples 1-3 includes, wherein the processor is further configured to: re-train or modify the AI/ML model; and in response to the AI/ML model being re-trained or modified, update the model card to an updated model card.

In Example 5, the subject matter of Example 4 includes, wherein the processor is further configured to: determine that the service consumer has subscribed with the AI/ML-driven network function to model card status notifications; and in response to a determination that the service consumer has subscribed with the AI/ML-driven network function, notify the service consumer of a change to the model card, notification to the service consumer including the updated model card.

In Example 6, the subject matter of Examples 4-5 includes, wherein the processor is further configured to: provide a network function profile to the NRF to register the AI/ML-driven network function with the NRF, the network function profile including a network function type, supported analytics services, and the model card; and notify the NRF of a change to the model card, notification to the NRF including the updated model card.

In Example 7, the subject matter of Examples 4-6 includes, wherein the processor is further configured to: provide a network function profile to the NRF to register the AI/ML-driven network function with the NRF, the network function profile including a network function type, and supported analytics services; register the model card in the dedicated model card registry network; and notify the NRF of a change to the model card through an update model card request, the update model card request including the updated model card.

In Example 8, the subject matter of Examples 4-7 includes, wherein the processor is further configured to notify at least one of the service consumer, the NRF, or the dedicated model card registry network of a change to the model card using a callback uniform resource identifier (URI).

In Example 9, the subject matter of Examples 1-8 includes, wherein the model card data includes ethics considerations, fairness metrics, and robustness metrics.

In Example 10, the subject matter of Examples 1-9 includes, wherein the processor is further configured to register the model card in the dedicated model card registry network through a create model card request sent to the dedicated model card registry network, the create model card request including the model card and NF instance identifier (ID), the analytics request received after registration of the model card in the dedicated model card registry network.

Example 11 is an apparatus of a network repository function (NRF) in a 6th generation (6G) network, the apparatus comprising a processor configured to: register an Artificial Intelligence/Machine Learning (AI/ML)-driven network function based on a network function profile received at the NRF, the network function profile including a network function type, supported analytics services, and model card of an AI/ML model in the AI/ML-driven network function that provides the supported analytics services; determine that a discovery request from a service consumer has been received, the discovery request including query parameters; use the query parameters to determine that the AI/ML-driven network function matches the discovery request; and in response to a determination that the AI/ML-driven network function matches the discovery request, provide a discovery response with the network function profile of the AI/ML-driven network function for evaluation of trustworthiness of the AI/ML model.

In Example 12, the subject matter of Example 11 includes, wherein the network function profile is received on an interface of the AI/ML-driven network function that is different from an interface used for the supported analytics services.

In Example 13, the subject matter of Examples 11-12 includes, wherein the query parameters include a network function type and network function attributes.

In Example 14, the subject matter of Examples 11-13 includes, wherein the model card is encoded as a JSON string.

In Example 15, the subject matter of Examples 11-14 includes, wherein the processor is further configured to: determine that the AI/ML model has been re-trained or modified based on reception of an update notification from the AI/ML-driven network function, the update notification including an updated network function profile including updated model card of the AI/ML model; and confirm to the AI/ML-driven network function reception of the update notification.

In Example 16, the subject matter of Example 15 includes, wherein the processor is further configured to: determine that the service consumer has subscribed to notification status updates of the AI/ML-driven network function; and in response to reception of the update notification from the AI/ML-driven network function, generate a service consumer notification for transmission to the service consumer, the service consumer notification including the updated network function profile.

In Example 17, the subject matter of Example 16 includes, wherein the service consumer notification is provided to a callback uniform resource identifier (URI).

In Example 18, the subject matter of Examples 11-17 includes, wherein the model card includes ethics considerations, fairness metrics, and robustness metrics.

Example 19 is a non-transitory computer-readable storage medium that stores instructions for execution by one or more processors of an apparatus of an Artificial Intelligence/Machine Learning (AI/ML)-driven network function in a 6th generation (6G) network, the instructions to cause the one or more processors to: generate a model card containing model card data of an AI/ML model deployed in the AI/ML-driven network function, the model card data including information for evaluation of trustworthiness of the AI/ML model; via a management interface, provide access to the model card in a local memory or register the model card in at least one of a network repository function (NRF) or a dedicated model card registry network; determine that an analytics request for analytics by the AI/ML model has been received, via an analytics interface, from a service consumer after a determination of the trustworthiness of the AI/ML model based on the model card; in response to a determination the analytics request by the AI/ML model has been received, use the AI/ML model to generate predictions; and provide a result based on the predictions to the service consumer.

In Example 20, the subject matter of Example 19 includes, wherein the instructions further cause the one or more processors to: provide a network function profile to the NRF to register the AI/ML-driven network function with the NRF, the network function profile including a network function type and supported services; determine that a fetch request from the service consumer has been received, the fetch request including a query parameter specifying a name of an inference service that is to be used; determine that the AI/ML model meets the inference service; and provide a fetch response that includes the model card encoded as a JSON string, the analytics request received after the fetch response is provided.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of an Artificial Intelligence/Machine Learning (AI/ML)-driven network function in a 6^{th} generation (6G) network, the apparatus comprising a processor configured to:
generate a model card containing model card data of an AI/ML model deployed in the AI/ML-driven network function, the model card data including information for evaluation of trustworthiness of the AI/ML model;
via a management interface, provide access to the model card in a local memory or register the model card in at least one of a network repository function (NRF) or a dedicated model card registry network;
determine that an analytics request for analytics by the AI/ML model has been received, via an analytics interface, from a service consumer after a determination of the trustworthiness of the AI/ML model based on the model card;
in response to a determination the analytics request by the AI/ML model has been received, use the AI/ML model to generate predictions; and
provide a result based on the predictions to the service consumer.

2. The apparatus of claim 1, wherein the processor is configured to:
provide a network function profile to the NRF to register the AI/ML-driven network function with the NRF, the network function profile including a network function type and supported services;
determine that a fetch request from the service consumer has been received, the fetch request including a query parameter specifying a name of an inference service that is to be used;
determine that the AI/ML model meets the inference service; and
provide a fetch response that includes the model card encoded as a JSON string, the analytics request received after the fetch response is provided.

3. The apparatus of claim 2, wherein the network function profile further includes the model card for the service consumer to access.

4. The apparatus of claim 1, wherein the processor is further configured to:
re-train or modify the AI/ML model; and
in response to the AI/ML model being re-trained or modified, update the model card to an updated model card.

5. The apparatus of claim 4, wherein the processor is further configured to:
determine that the service consumer has subscribed with the AI/ML-driven network function to model card status notifications; and
in response to a determination that the service consumer has subscribed with the AI/ML-driven network function, notify the service consumer of a change to the model card, notification to the service consumer including the updated model card.

6. The apparatus of claim 4, wherein the processor is further configured to:
provide a network function profile to the NRF to register the AI/ML-driven network function with the NRF, the network function profile including a network function type, supported analytics services, and the model card; and
notify the NRF of a change to the model card, notification to the NRF including the updated model card.

7. The apparatus of claim 4, wherein the processor is further configured to:
provide a network function profile to the NRF to register the AI/ML-driven network function with the NRF, the network function profile including a network function type, and supported analytics services;
register the model card in the dedicated model card registry network; and
notify the NRF of a change to the model card through an update model card request, the update model card request including the updated model card.

8. The apparatus of claim 4, wherein the processor is further configured to notify at least one of the service consumer, the NRF, or the dedicated model card registry network of a change to the model card using a callback uniform resource identifier (URI).

9. The apparatus of claim 1, wherein the model card data includes ethics considerations, fairness metrics, and robustness metrics.

10. The apparatus of claim 1, wherein the processor is further configured to register the model card in the dedicated model card registry network through a create model card request sent to the dedicated model card registry network, the create model card request including the model card and NF instance identifier (ID), the analytics request received after registration of the model card in the dedicated model card registry network.

11. An apparatus of a network repository function (NRF) in a 6^{th} generation (6G) network, the apparatus comprising a processor configured to:
register an Artificial Intelligence/Machine Learning (AI/ML)-driven network function based on a network function profile received at the NRF, the network function profile including a network function type, supported analytics services, and model card of an AI/ML model in the AI/ML-driven network function that provides the supported analytics services;
determine that a discovery request from a service consumer has been received, the discovery request including query parameters;
use the query parameters to determine that the AI/ML-driven network function matches the discovery request; and
in response to a determination that the AI/ML-driven network function matches the discovery request, provide a discovery response with the network function profile of the AI/ML-driven network function for evaluation of trustworthiness of the AI/ML model.

12. The apparatus of claim 11, wherein the network function profile is received on an interface of the AI/ML-driven network function that is different from an interface used for the supported analytics services.

13. The apparatus of claim 11, wherein the query parameters include a network function type and network function attributes.

14. The apparatus of claim 11, wherein the model card is encoded as a JSON string.

15. The apparatus of claim 11, wherein the processor is further configured to:
determine that the AI/ML model has been re-trained or modified based on reception of an update notification from the AI/ML-driven network function, the update notification including an updated network function profile including updated model card of the AI/ML model; and
confirm to the AI/ML-driven network function reception of the update notification.

16. The apparatus of claim 15, wherein the processor is further configured to:
determine that the service consumer has subscribed to notification status updates of the AI/ML-driven network function; and
in response to reception of the update notification from the AI/ML-driven network function, generate a service consumer notification for transmission to the service consumer, the service consumer notification including the updated network function profile.

17. The apparatus of claim 16, wherein the service consumer notification is provided to a callback uniform resource identifier (URI).

18. The apparatus of claim 11, wherein the model card includes ethics considerations, fairness metrics, and robustness metrics.

19. A non-transitory computer-readable storage medium that stores instructions for execution by one or more processors of an apparatus of an Artificial Intelligence/Machine Learning (AI/ML)-driven network function in a 6^{th} generation (6G) network, the instructions to cause the one or more processors to:
generate a model card containing model card data of an AI/ML model deployed in the AI/ML-driven network function, the model card data including information for evaluation of trustworthiness of the AI/ML model;
via a management interface, provide access to the model card in a local memory or register the model card in at least one of a network repository function (NRF) or a dedicated model card registry network;
determine that an analytics request for analytics by the AI/ML model has been received, via an analytics interface, from a service consumer after a determination of the trustworthiness of the AI/ML model based on the model card;
in response to a determination the analytics request by the AI/ML model has been received, use the AI/ML model to generate predictions; and
provide a result based on the predictions to the service consumer.

20. The non-transitory computer-readable storage medium of claim 19, wherein the instructions further cause the one or more processors to:
provide a network function profile to the NRF to register the AI/ML-driven network function with the NRF, the network function profile including a network function type and supported services;
determine that a fetch request from the service consumer has been received, the fetch request including a query parameter specifying a name of an inference service that is to be used;
determine that the AI/ML model meets the inference service; and
provide a fetch response that includes the model card encoded as a JSON string, the analytics request received after the fetch response is provided.
